(19) United States
(12) Patent Application Publication
(10) Pub. No.: US 2010/0153709 A1
(43) Pub. Date: Jun. 17, 2010

(54) Trust Establishment From Forward Link Only To Non-Forward Link Only Devices

(75) Inventors: Panagiotis Thomas, Carlsbad, CA (US); Bijan Ansari, San Diego, CA (US); Patrick J. Hughes, Dana Point, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/634,388

(22) Filed: Dec. 9, 2009

Related U.S. Application Data
(60) Provisional application No. 61/121,536, filed on Dec. 10, 2008.

(51) Int. Cl. H04L 29/06; H04L 9/00

(52) U.S. Cl. 713/155; 713/171

(57) ABSTRACT

In the present system three methods are provided for establishing trust between an accessory device and a host device, without placing trust in the device/host owner, so that content protection for subscriber-based mobile broadcast services is provided. That is, a secure link may be established between the accessory device and the host device so when the accessory device receives encrypted content via a forward link only network, the accessory device may decrypt the content at the forward link only stack and then re-encrypt it or re-secure it using the master key or some other derived key based on the master key (or the session key) and then send it to the host device which can decrypt it play it back.

### CLAIM OF PRIORITY UNDER 35 U.S.C. §119

The present application for patent claims priority to U.S. Provisional Application No. 61/121,536 entitled “Trust Establishment From Forward Link Only (FLO) To Non-FLO Devices”, filed Dec. 10, 2008, assigned to the assignee hereof and hereby expressly incorporated by reference herein.

### BACKGROUND

1. Field

One feature relates to providing content protection for subscriber-based mobile broadcast services. More specifically, trust is established between an accessory device and host device without placing trust in the device/host owner.

2. Background

Wireless networking systems have become a prevalent means to communicate with others worldwide. Wireless communication devices, such as cellular telephones, personal digital assistants, and the like have become smaller and more powerful in order to meet consumer needs and to improve portability and convenience. Consumers have become dependent upon these devices, demanding reliable service, expanded areas of coverage, additional services (e.g., web browsing capabilities), and continued reduction in size and cost of such devices.

A typical wireless communication network (e.g., employing frequency, time, and/or code division techniques or a combination thereof) includes one or more base stations that provide coverage areas to subscribers as well as mobile (e.g., wireless) devices that can transmit and/or receive data within the coverage areas. A typical base station can simultaneously transmit multiple data streams to multiple devices for broadcast, multicast, and/or unicast services, wherein a data stream is a stream of data that can be of independent reception interest to a user device. A user device within the coverage area of that base station can be interested in receiving one, more than one or all the data streams carried by the composite stream. Likewise, a user device can transmit data to the base station and/or another user device.

Forward link only technology has been developed by an industry group of wireless communication service providers to utilize the latest advances in system design to achieve the highest-quality performance. Forward link only technology is intended for a mobile multimedia environment and is suited for use with mobile user devices. Forward link only technology is designed to achieve high quality reception, both for real-time (streaming) content and other data services. Forward link only technology can provide robust mobile performance and high capacity without compromising power consumption. In addition, the technology reduces the network cost of delivering multimedia content by decreasing the number of base station transmitters that are necessarily deployed. Furthermore, forward link only technology based multimedia multicasting is complimentary to wireless operators' cellular network data and voice services, as cellular network data can be delivered to a same device that receives multimedia content by way of forward link only technology.

Once such forward link only technology is MediaFLO, by Qualcomm. Inc., which broadcasts data to portable access terminals such as cell phones and personal digital assistants (PDA). MediaFLO is a subscriber-based service and requires the device receiving the service to have an embedded forward link only receiver. However, service may now be extended to devices that do not have an embedded forward link only receiver. To utilize the service, a user may purchase a forward link only receiver, hereafter referred to as an “Accessory Device” that can stream content to a non-forward link only device, hereafter referred to as a “Host Device”.

Content providers as well as MediaFLO service operators mandate that such service deployment is robust against the following attacks: (1) Extract unencrypted digital content from the accessory device, the host device, or the communication link between the two; (2) Stream MediaFLO content to host devices that are not in the specified list of ‘approved host types’; (3) Stream MediaFLO content to more than one host device at a time; and (4) Stream MediaFLO content to a host device without the consent of the device owner.

However, in MediaFLO systems, content is encrypted only up to the forward link only protocol stack or accessory device. As a result, the transmission of the content from the forward link only protocol stack to the host device is not secure. Therefore, a method is needed for establishing trust between the accessory device and host device without placing trust in the device/host owner.

### SUMMARY

The following presents a simplified summary of one or more embodiments in order to provide a basic understanding of some embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to one feature, a method operational in a security server is provided for establishing trust between an accessory device and a host device. The accessory device may be a forward link only receiver while the host device may be a non-forward link only device. The security server may include a key server, a host trust agent provider, which may have an established trust with the host device separate from the accessory device, and an accessory trust agent provider, which may have an established trust with the accessory device separate from the host device. Each of the trusted agents, i.e. the host trust agent provider and the accessory trust agent provider, may be an application executed by the accessory device or the host device. The application may be a flash player that could be an application with information embedded inside the application. The application may use the embedded information to establish the secure connection.

When establishing trust between the accessory device and the host device, the security server may first receive an accessory device identifier and a host device identifier via a first network. Using the accessory device identifier and the host device identifier, the key server may generate a master key. The master key, along with the accessory device identifier may then be sent to the accessory trust agent provider which may then generate an accessory token based on the accessory device identifier and a master key. Once generated, the accessory token may be sent from the accessory trust agent provider to the key server.

After receiving the accessory token, the key server may then send the host device identifier and the master key to the host trust agent provider which may then generate a host token based on the host device identifier and the master key. Once generated, the accessory token may be sent from the host trust agent provider to the key server. When the key server has both the host token and the accessory token, it may send them, via a second network over a forward link only interface, to the accessory device. The host token and the accessory token may then be used by the host device and the accessory device, respectively, to establish a session key which may be used to securely sending content between the accessory device and the host device.

Additionally, the key server may deliver empty tokens, a command to perform a task or tokens with new master keys to revoke or renew the session key between the accessory device and the host device.

According to one feature, an accessory device may establish trust with a host device for securely sending content. The accessory device may include a first communication interface that communicates with a subscriber-based server and a second communication interface that communicates with the host device. A processing circuit may be coupled to the first and second communication interfaces for receiving an accessory token and a host token from a security server via a second network over a forward link only interface. Once the accessory token and the host token are received, the accessory device may decrypt the master key from the accessory token. Upon generation of the master key, any trust previously established with the host device based on an old master key may be revoked. Next, the accessory device may receive a host device identifier from the host device via a first network and then send the host token, previously received from the security server, via the first network, when the accessory device is connecting to the host device for the first time. Using the master key, the accessory device may derive a session key which may be used for securely sending content to the host device as the content is encrypted with the session key.

According to one feature, a host device may establish trust with an accessory device for securely receiving content from the accessory device. The accessory device may be a forward link only receiver. The host device may include a first communication interface that communicates with a subscriber-based server and a second communication interface that communicates with the accessory device. A processing circuit may be coupled to the first and second communication interfaces for delivering a host device identifier to the accessory device. As a result of delivering the host device identifier, the host device may receive a host token from the accessory device if this is the first time that the host device and accessory device have established a connection. The host device may then decrypt a master key from the host token and use the master key to derive a session key which may be used to securely receive content from the accessory device as the content is encrypted with the session key.

According to another feature, a method operational on a host device is provided for establishing trust with an accessory device. When establishing trust with the accessory device, the host device may first send an accessory device identifier and a host device identifier to a security server via a first network to the accessory device. Next, an accessory token and a host token may be sent to the host device from the security server, via a second network, and the host device may then decrypt a master key from the accessory token. Upon decryption of the master key, any trust previously established with the accessory device based on an old master key may be revoked. The host identifier may then be sent to the accessory device and the accessory token that corresponds to the host device identifier may then be sent to the accessory device when connecting to the accessory device for the first time. A session key may be derived by the host device using the master key and the host device identifier. The session key between the accessory device and the host device may be temporary. The session key may be used to decrypt content which the host device receives from the accessory device encrypted with the session key. The content received from the accessory device may be real-time content.

Similarly, a host device is provided for establishing trust with an accessory device. The host device may include a first communication interface for communicating with a subscriber-based service and a second communication interface for communication with the accessory device. A processing circuit coupled to the first and second communication interfaces may cause the host device to send an accessory device identifier and a host device identifier to a security server via a first network; receive an accessory token and a host token from the security server, via a second network, over a forward link only interface, the accessory token and the host token utilized to establish a session key between the accessory device and the host device; decrypt a master key from the accessory token; send the host device identifier to the accessory device; send the accessory token to the accessory device when connecting the accessory device to the host device for the first time; derive a session key from the master key; and receive content from the accessory device encrypted with the session key via the first network.

Similarly, a computer-readable medium comprising instructions executable by a processor for establishing trust between an accessory device and a host device is provided. The instructions include sending an accessory device identifier and a host device identifier to a security server via a first network; receiving an accessory token and a host token from the security server, via a second network, over a forward link only interface, the accessory token and the host token utilized to establish a session key between the accessory device and the host device; decrypting a master key from the accessory token; sending the host device identifier to the accessory device; sending the accessory token to the accessory device when connecting the accessory device to the host device for the first time; deriving a session key from the master key; and receiving content from the accessory device encrypted with the session key via the first network.

According to another feature, a method operational on an accessory device is provided for establishing trust with a host device. The accessory device may be a forward link only receiver. When establishing trust with the host device, the accessory device may first receive a host device identifier from the host device. Next, an accessory token, corresponding to the host device identifier, may be received from the host device when connecting to the host device for the first time. After receiving the accessory token, the accessory device may decrypt the master key from the accessory token and derive a session key from the master key. The session key between the accessory device and the host device may be temporary. Content encrypted with the session key may then be transmitted to the host device. The transmitted content may be real-time content.

Similarly, an accessory device is provided for establishing trust with a host device. The accessory device includes a first communication interface for communicating with a subscriber-based service and a second communication interface for communicating with the host device. A processing circuit coupled to the first and second communication interfaces may cause the accessory device to receive a host device identifier from the host device; receive an accessory token, corresponding to the host device identifier, from the host device when connecting the accessory device to the host device for the first time; decrypt a master key from the accessory token; derive a session key from the master key; and transmit content to the host device encrypted with the session key.

Similarly, a computer-readable medium comprising instructions executable by a processor for establishing trust between an accessory device and a host device is provided. The instructions include receiving a host device identifier from the host device; receiving an accessory token, corresponding to the host device identifier, from the host device when connecting the accessory device to the host device for the first time; decrypting a master key from the accessory token; deriving a session key from the master key; and transmitting content to the host device encrypted with the session key.

According to yet another feature, an accessory device is provided for establishing trust with a host device. The accessory device may include a first communication interface that communicates with a subscriber-based server and a second communication interface that communicates with the host device. A processing circuit may be coupled to the first and second communication interfaces for installing a public key of a certificate authority in a trust agent of the accessory device and receiving a certificate revocation list via a forward link only interface. The certificate revocation list may be received through software updates installed on the accessory device through direct connection of the accessory device to a personal computer or through a network line with the host device. Next, a trust establishment phase on the accessory device may be initiated by an end user and a signed host device certificate may be received from the host device. The accessory device may then validate the host device certificate and generate the master key from the signed certificate. Next, the accessory device may send the master key, encrypted with the public key of the host device, to the host device. The accessory device may then derive a session key from the master key and then send content, encrypted with the session key, to the host device.

According to yet another feature, a host device is provided for establishing trust with an accessory device. The host device may include a first communication interface that communicates with a subscriber-based server and a second communication interface that communicates with the accessory device. A processing circuit may be coupled to the first and second communication interfaces for installing a private key and a signed certificate on a trust agent of the host device. The signed certificate may be, for example, a certificate based on a host device public key and a host device type which may be signed by a Certificate Authority. Once provisioned with the private key and signed certificate, the trust establishment phase on the host device may be initiated by the end user and the signed certificate may be sent to the accessory device. The host device may then receive the master key encrypted with the public key of the host device from the accessory device and then decrypt the master key. Next, any trust established using a previous master key may be revoked. The host device may then derive a session key from the master key so that it may receive content encrypted with the session key from the accessory device.

### BRIEF DESCRIPTION OF THE DRAWINGS

The features, nature, and advantages of the present features may become more apparent from the detailed description set forth below when taken in conjunction with the drawings in which like reference characters identify correspondingly throughout.

FIG. 1 is a block diagram illustrating an example of forward link only technology deployment.

FIG. 2 (comprising FIGS. 2A and 2B) is a flow diagram illustrating one example of establishing trust between an accessory device and a host device.

FIG. 3 is a block diagram illustrating an example of an accessory device configured to establish trust with a host device.

FIG. 4 illustrates a flow chart of a method, operational on an accessory device, of one example of establishing trust between the accessory device and a host device.

FIG. 5 illustrates a block diagram illustrating an example of a host device configured to establish trust with an accessory device.

FIG. 6 illustrates a flow chart of one example of a method, operational on a host device, for establishing trust between an accessory device and the host device.

FIG. 7 is a block diagram illustrating an example of a security server configured to establish trust between an accessory device and a host device.

FIG. 8 illustrates a flow chart of one example of a method, operational on a security server, for establishing trust between an accessory device and a host device.

FIG. 9 (comprising FIGS. 9A and 9B) is a flow diagram illustrating an example of establishing trust between an accessory device and a host device.

FIG. 10 illustrates a flow diagram of one example of a method, operational on an accessory device, for establishing trust between the accessory device and a host device.

FIG. 11 illustrates a flow diagram of one example of a method, operational on a host device, for establishing trust between an accessory device and the host device.

FIG. 12 illustrates a flow chart of one example of a method, operational on a security server, for establishing trust between an accessory device and a host device.

FIG. 13 is a flow diagram illustrating an example of establishing trust between an accessory device and a host device.

FIG. 14 illustrates a flow diagram of one example of a method, operational on a host device, for establishing trust between an accessory device and the host device.

FIG. 15 illustrates a flow diagram of one example of a method, operational on an accessory device, for establishing trust between the accessory device and a host device.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

In the following description, certain terminology is used to describe certain features. The term “accessory device”, includes, but is not limited to, a forward link only receiver. The term “host device”, includes, but it not limited, to a non-forward link only device.

Identified below are a list of acronyms and definitions used through this application.

### ACRONYMS & DEFINITIONS

[x]_{ID} Value x encrypted (and potentially signed) for delivery to a trust agent on the device (accessory or host) with the specified ID. In the sequel, [x]_{ID} may be referred to as ‘token’.
Cert{x, y} Certificate containing values x and y.
E{key} {value} Encrypted value using key.
ID.ACC Unique identifier of accessory device. It may be possible to map the ID.ACC to the trust agent running on that device.
ID.Host Unique identifier of host device. It may be possible to map the ID.Host to the trust agent running on that device.
publicKey.Host Public key of host device
Trust agent A Trust agent may be an entity that cannot be easily copied, modified, or reverse engineered and can also protect secret data against unauthorized disclosure.
type.Host Type of host device.

### Overview

A security system may be applied to content transmissions over a broadcast/multicast network infrastructure. The broadcast network infrastructure may be Evolution-Data Only Broadcast Multicast Services (BCMCS) that facilitates distribution of a subscription-based content delivery service. Upon subscribing to the content delivery service, the subscriber host device may be given the service key. A broadcast access key may be generated by the broadcast network infrastructure and used to encrypt content to be broadcasted. Consequently, only host devices that have received the service key (e.g., subscribe to the associated subscription package) can decrypt the broadcasted content.

### Network Environment

One example of a subscriber-based forward link only service is MediaFLO, by Qualcomm Inc., which broadcasts data to portable access terminals (or host devices) such as cell phones and PDAs. Broadcast data may include multiple real-time audio and/or video streams, individual, non-realtime video and/or audio “clips”, as well as internet protocol (IP) datacast application data such as stock market quotes, sports scores, and weather reports. The “F-L-O” in MediaFLO stands for forward link only, meaning that the data transmission path is one-way, from the tower/server to the host device. MediaFLO addresses the inherent spectral inefficiency of unicasting high-rate full-motion video/audio to multiple subscribers (access terminals) but instead broadcasting such content. To limit access to the broadcasted content to subscribers, the content may be secured or encrypted by a key known only to subscriber host devices. MediaFLO content delivery may be implemented, for example, over an Evolution-Data Optimized or Evolution-Data only (EVDO) network that authenticates subscriber host devices and distributes the keys used to decode the programming.

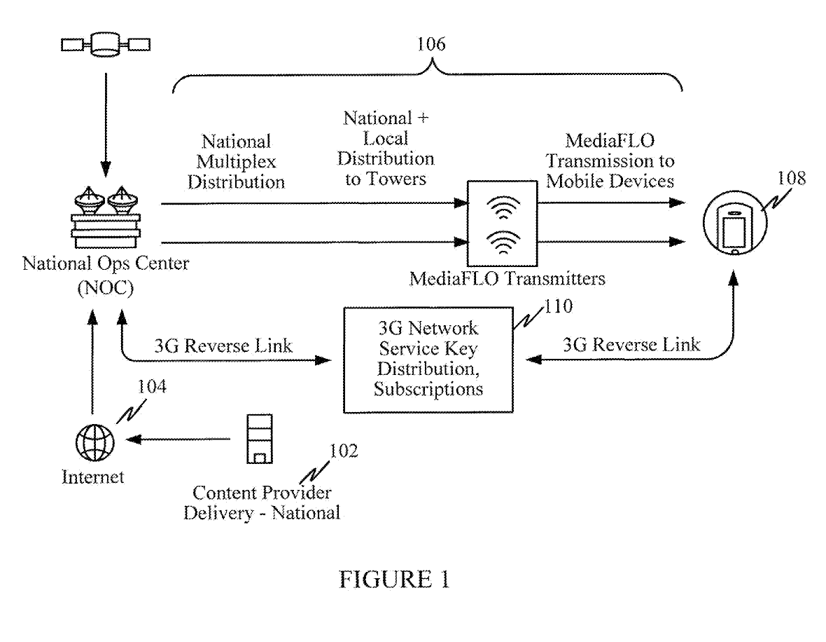

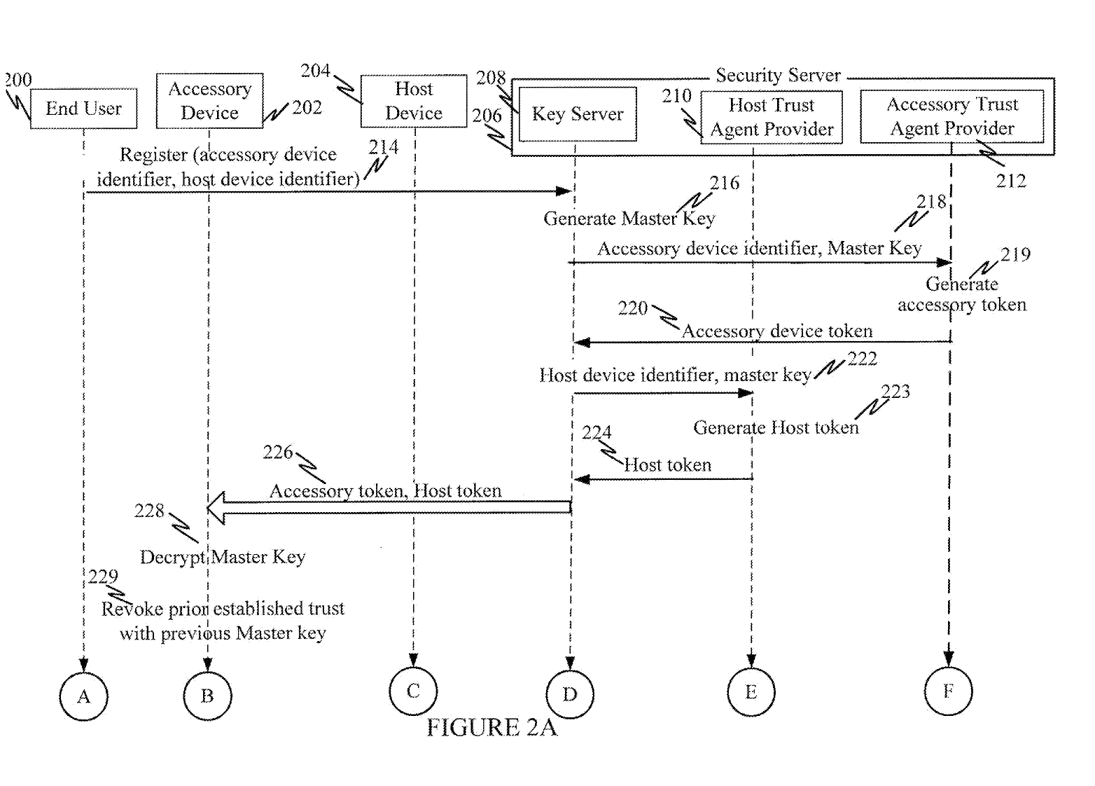

FIG. 1 is a block diagram illustrating an example of forward link only technology deployment. Real-time content may be received directly from content providers 102, while non-real-time content can also be received over the Internet 104. The content may be reformatted into forward link only packet streams and distributed over a distribution network. In the target market, the content may be received and forward link only packets may be converted to a forward link only waveform 106 and radiated to host devices 108. A 3G cellular network 110 may provide interactivity and facilitate user authorization.

### Assumptions

In the present system three methods are provided for establishing trust between an accessory device and a host device. In each of these methods, one or more assumptions can be made. These assumptions include: (1) every host device and accessory device may be pre-provisioned with a trusted module, hereafter referred to as “trust agent”. The trusted agent may not be easily copied, modified or reverse engineered and may protect secret data against unauthorized disclosure. (2) Each trust agent may have pre-established trust (e.g. a shared cryptographic key) with a network side component, hereafter referred to as “Trust Agent Provider”. In other words, there may be a mechanism in place for the Trust Agent Provider to securely encapsulate (e.g. encrypt, sign) information for delivery to a trust agent. The accessory device and host device may have different Trust Agent Providers. Moreover, Trust Agent Providers may not be the same among all accessory devices or all host devices. (3) There may be a mechanism in place for the trust agent on the host device to authenticate to the accessory device and attest to the host device type.

Table 1 below depicts which assumptions may apply to each of the methods described in detail below.

TABLE 1

| | Assumption 1 | Assumption 2 | Assumption 3 |
|---|---|---|---|
| Broadcast | X | X | |
| Channel | | | |
| Delivery | | | |
| Interactive | X | X | |
| Channel | | | |
| Delivery | | | |
| Autonomous | X | | X |
| Trust Agents | | | |

### Dependent Trust Agents and Broadcast Channel Delivery

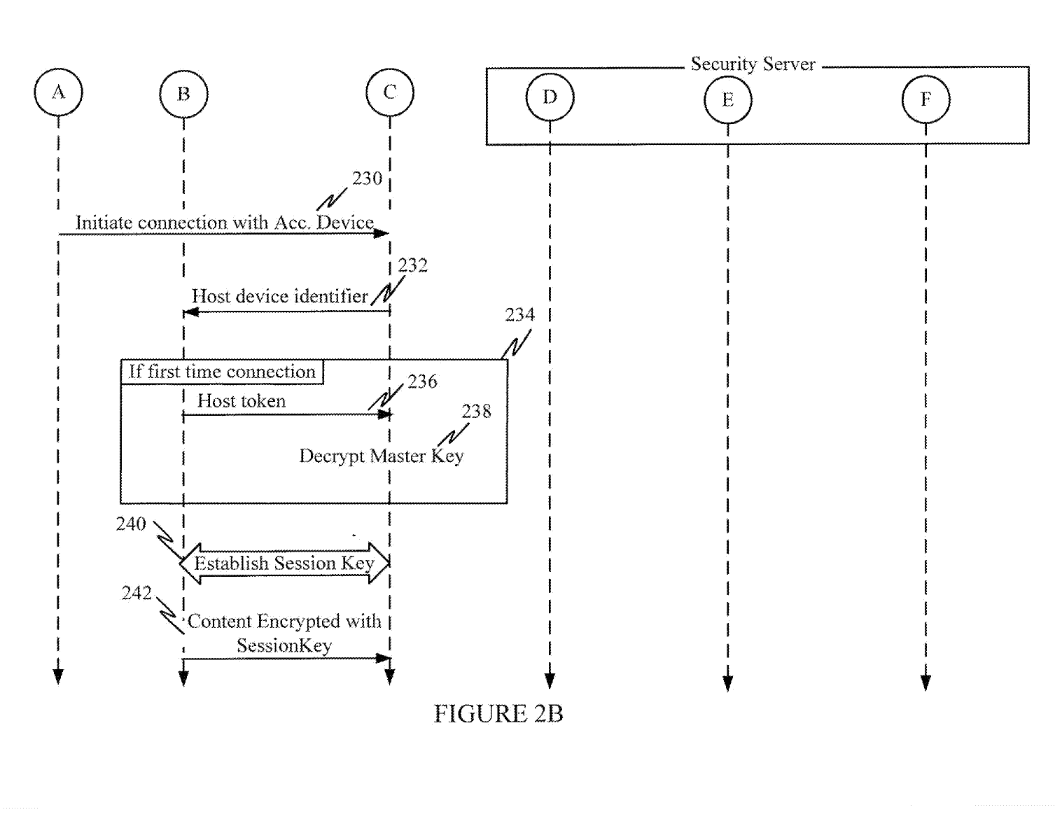

FIG. 2 (comprising FIGS. 2A and 2B) is a flow diagram illustrating one example of establishing trust between an accessory device and a host device. In this example, an end user 200 may establish trust between the accessory device 202 and the host device 204 through a security server 206. The security server may include a key server 208, a host trust agent provider 210, which may have an established trust with the host device separate from the accessory device, and an accessory trust agent provider 212, which may have an established trust with the accessory device separate from the host device. Each of the trusted agents, i.e. the host trust agent provider and the accessory trust agent provider, may be an application executed by the accessory device or the host device. The application may be a flash player that could be an application with information embedded inside the application. The application may use the embedded information to establish the secure connection.

In one aspect, a key may be placed inside the application at the factory, i.e. the key may be inside the application, inside the trusted agent, the host device for example. In another aspect, the key may be embedded inside the application and the owner may download the application from a website. As the infrastructure, i.e. the host trust agent provider, knows the key, the key may be known to both the accessory device and the host device.

A master key may be generated and each trust agent provider may create a token (secure envelope containing the master key) for delivery to the corresponding trust agent. Both tokens may be delivered to the accessory device over a forward link only interface. Upon first connection, the accessory device may deliver the token generated by the host trust agent provider to the host device. Both devices may use the master key to derive a session key that may then be used for encrypting the streamed content.

First, the owner (or end user) of the accessory device may log onto his/her MediaFLO web account and register an accessory device and host device by sending the identifier (ID) of the host device (ID.Host) and the ID of the accessory device (ID.ACC) to the key server located in the security server 214. The identifiers may be serial numbers of the accessory device and the host device or may be any other identifying number that uniquely identifies the accessory device and the host device.

In other words, to register the accessory device and the host device, the owner (or end user) may navigate to a registration website after identifying the unique identifying numbers of the accessory device and the host device. The unique identifying numbers may be entered on the website (or security server). Upon receiving the identifiers, the key server may generate a master key 216. The key server may then send, or deliver, the accessory device ID (ID.ACC) received from the end user, along with the master key (MasterKey), to the accessory trust agent provider in the security server 218. Using the master key and the accessory device ID, the accessory trust agent provider may generate an accessory token ([MasterKey]_{ID.ACC}) 219 and send the accessory token ([MasterKey]_{ID.ACC}) to the key server 220.

Once the key server receives the accessory token ([MasterKey]_{ID.ACC}), it may then deliver the host device ID (ID.Host), along with the master key (MasterKey), to the host trust agent provider in the security server 222. Using the host device ID and the master key, the host trust agent provider may generate a host token ([MasterKey]_{ID.Host}) 223 and then send the host token ([MasterKey]_{ID.Host}) to the key server 224. After the key server has received the accessory token (MasterKey_{ID.ACC}) and the host token ([MasterKey]_{ID.Host}), both tokens may be delivered to the accessory device over the forward link only interface 226. In other words, once the infrastructure (or security server) has the tokens, it may then forward them through the forward link only link to the accessory device as a pair of keys. The pair of keys may include one key encrypted in two different ways. One of the keys may be for the accessory device and the other key may be for the host device.

The accessory device may then decrypt one of the two keys as it is encrypted with the accessory device identifier. The other key may be encrypted with the host device identifier and cannot be decrypted by the accessory device so the accessory device may forward the other key to the host device which can then decrypt it. In other words, the accessory device may extract the master key from the accessory token 228. Once the master key has been decrypted, the trust established with a previous master key may be revoked 229. The end user may then initiate the connection of the host device to the accessory device (i.e. a secure session) as the host device and accessory device both have the master key 230.

Once a secure connection between the accessory device and the host device is initiated, the host device may deliver its identifier (ID.Host) to the accessory device 232. If this is the first time the host device connects to the accessory device 234, the accessory device may return the host token ([MasterKey]_{ID.Host}), corresponding to the received host device ID, to the host device 236. The host device may then decrypt the master key from the host token ([MasterKey]_{ID.Host}) 238. The accessory and host devices may then derive a session key based on the master key 240 so that content may then be delivered to the host device, from the accessory device, encrypted with the session key 242. In one aspect, the content is real-time content.

In other words, there may be a secure link between the accessory device and the host device so when the accessory device receives the encrypted content via the forward link only network, the accessory device may decrypt the content at the forward link only stack and then re-encrypt it or re-secure it using the master key or some other derived key based on the master key (or the session key) and may then send it to the host device which can decrypt it play it back.

In one aspect, the trust established between the accessory device and host device may be made temporary by including an expiration time. As discussed above, the key server can revoke or renew previously established trust between the accessory device and the host device. Revocation may occur by delivering empty tokens, a token which includes a command to perform a task, or tokens with new master keys. The task may include a revocation of the master key.

For example, the master key may be revoked as the host device may be compromised as the same host device is being received in multiple requests for registration. To revoke the master key so that the accessory device is aware of the revocation, a message may be sent to the accessory device indicating that the master key is to be revoked. For example, the accessory device may have a direct link to the forward link only network. Alternatively, a mechanism may be included in the accessory device so that the host device renews the master key at specific intervals, such as every month or every week. The host device may request the infrastructure to provide a new key, however, if the host device is compromised, the infrastructure may refuse to give the host device a new key.

In yet another aspect, the host token may be delivered to the host device along with the MediaFLO application (user interface, player, etc.) that may allow the host device to connect to the accessory device and render the service to the user.

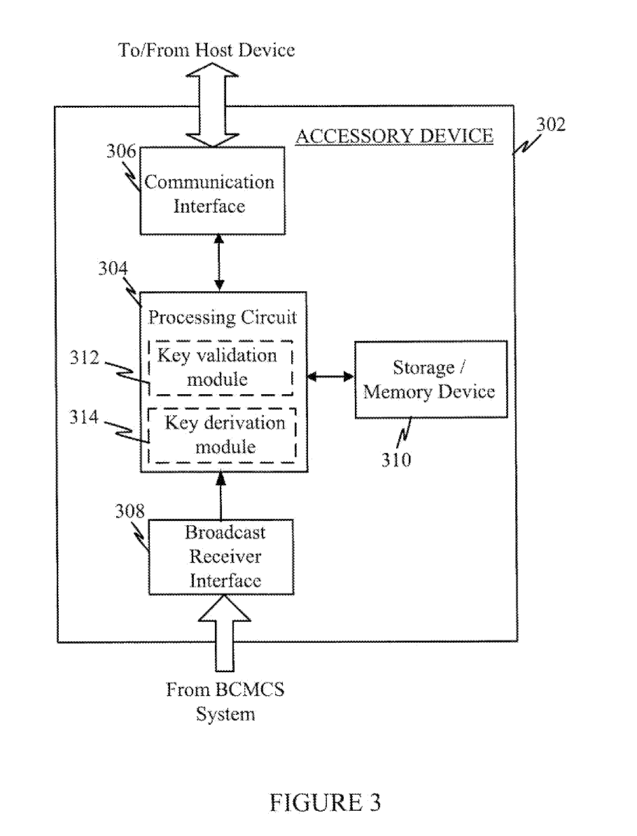

FIG. 3 is a block diagram illustrating an example of an accessory device configured to establish trust with a host device. The accessory device 302 may include a processing circuit 304 coupled to a communication interface 306, a broadcast receiver interface 308, and/or a storage/memory device 310. The processing circuit 304 may include a key validation module 312 and a key derivation module 314. The accessory device 302 may receive content, keys and other information. The accessory device 302 may also be provisioned with other information for a broadcast/multicast services (BCMCS) system (e.g., via a forward link only network). The key validation module 312 may utilize a Certificate Authority public key to validate certificates received from host devices and the key derivation module 314 may derive master keys and session keys. The communication interface 306 may be a wired or wireless communication interface through which the accessory device may communicate with one or more host devices.

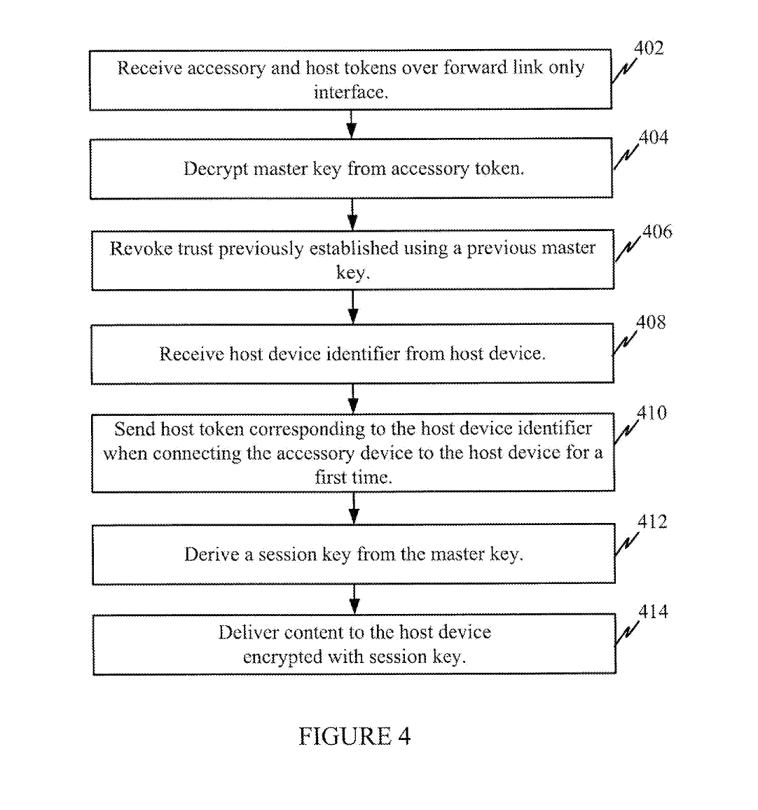

FIG. 4 illustrates a flow chart of a method, operational on an accessory device, of one example of establishing trust between the accessory device and a host device. First, accessory and host tokens may be delivered to, or received by, the accessory device over a forward link only interface 402. Once the tokens have been received, the accessory device may decrypt a master key from the accessory token 404. Once the master key has been decrypted, a prior trust, established with a previous master key, may be revoked 406. A host device identifier (ID.HOST) may then be received from the host device 408. The accessory device may then send the host token, corresponding with the host device identifier (ID.HOST), to the host device when connecting to the host device for the first time 410. Next, the accessory device may establish or derive a session key from the master key 412. Once both the accessory device and the host device have derived the session key, the accessory device may deliver content to the host device encrypted with the session key 416. In one aspect, the content may be real-time content.

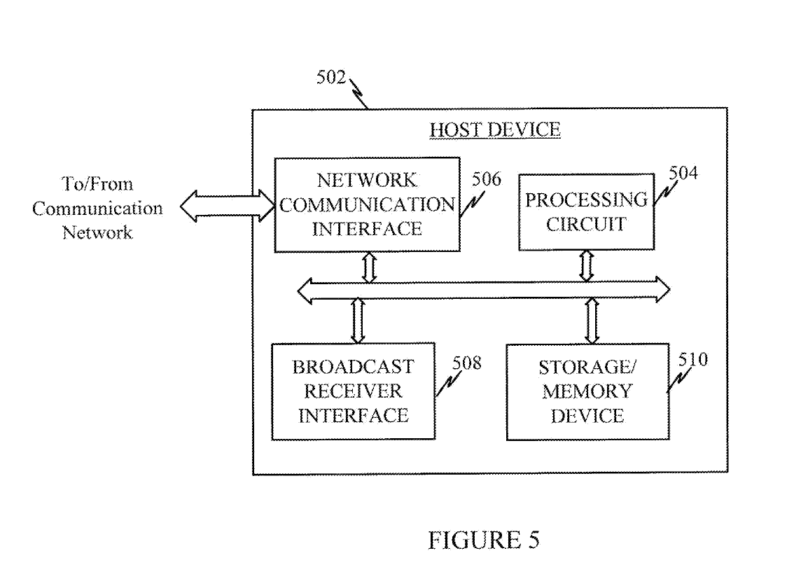

FIG. 5 illustrates is a block diagram illustrating an example of a host device configured to establish trust with an accessory device. The host device 502 may include a processing circuit (e.g., processor, processing module, etc.) 504 coupled to a network communication interface 506, a broadcast receiver interface 508 and/or a storage/memory device 510 to store content, keys and other information received.

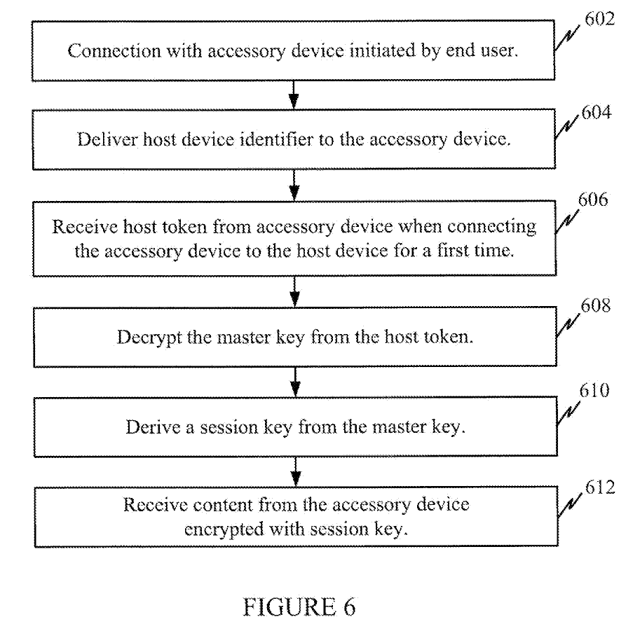

FIG. 6 illustrates a flow chart of one example of a method, operational on a host device, for establishing trust between an accessory device and the host device. First, a connection between the host device and the accessory device may be initiated by the end user 602. After the connection is established, the host device may deliver its host identifier (ID.Host) to the accessory device 604. Upon receiving the host device identifier (ID.Host) from the accessory device, the host device may receive the host token ([MasterKey]_{ID.Host}) from the accessory device when connecting the accessory device to the host device for a first time 606. The host device may then decrypt the master key from the host token ([MasterKey]_{ID.Host}) 608. The master key may then be used to establish or derive a session key 610. The host device may then receive content from the accessory device encrypted with the session key 612. In one aspect, the content may be real-time content.

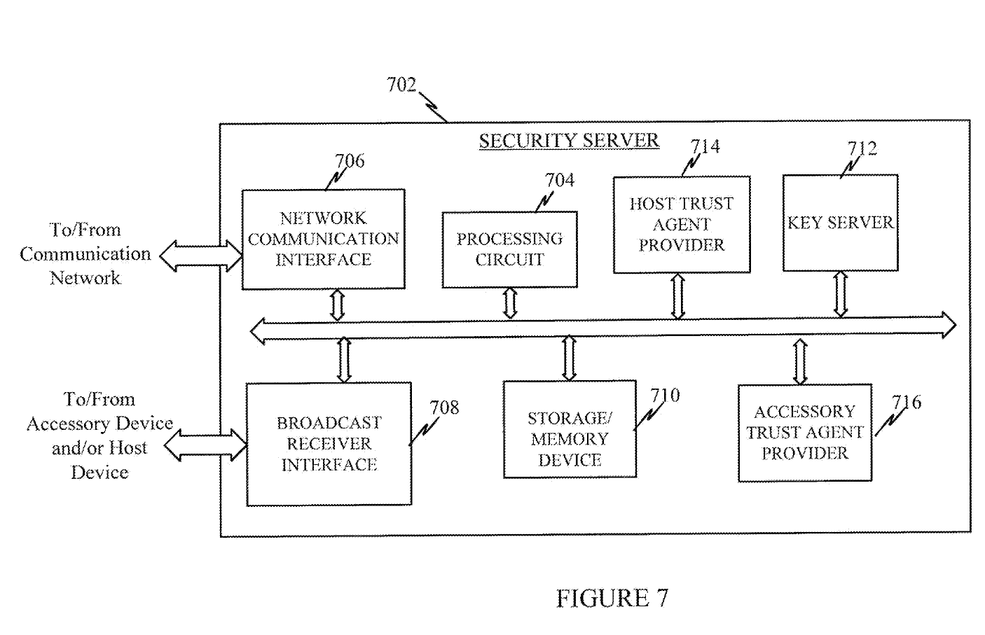

FIG. 7 is a block diagram illustrating an example of a security server configured to establish trust between a host device and an accessory device. The security server 702 may include a processing circuit 704 coupled to a network communication interface 706, a broadcast receiver interface 708 and/or a storage/memory device 710 for storing keys, content and other information. The security server 702 may also include a key server 712, a host trust agent provider 714 and an accessory trust agent provider 716.

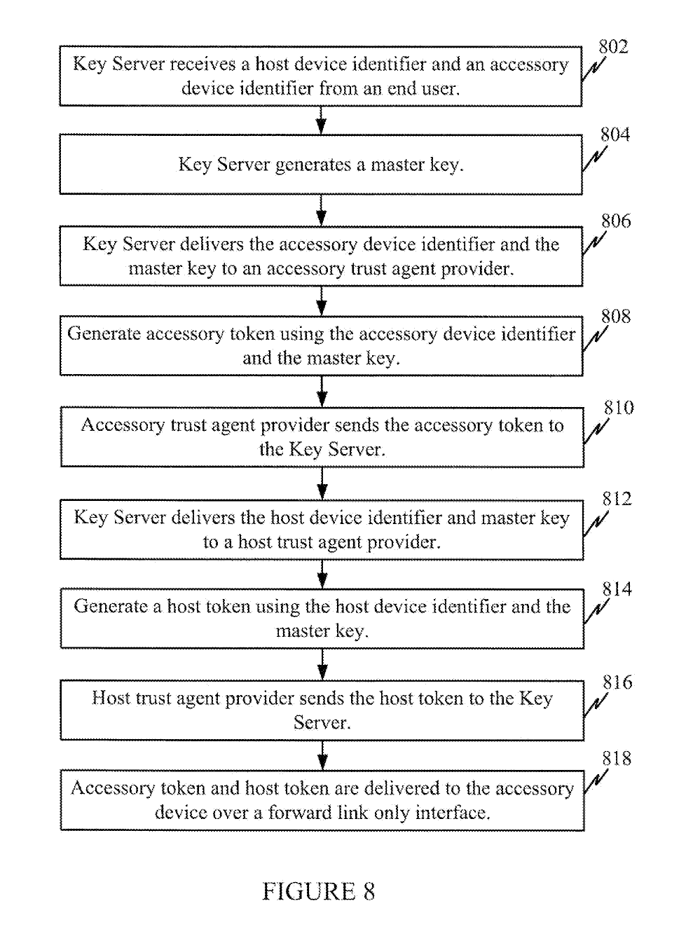

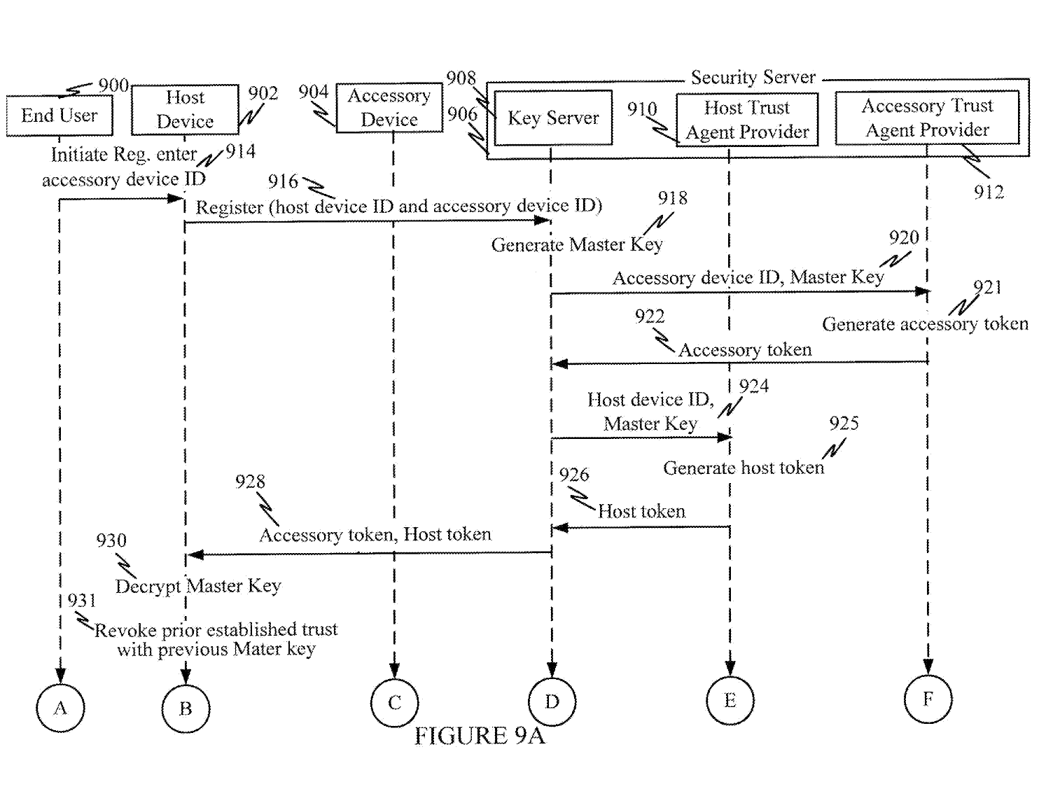

FIG. 8 illustrates a flow chart of one example of a method, operational on a security server, for establishing trust between an accessory device and a host device. First, a key server may receive a host device identifier and an accessory device identifier from an end user upon logging onto an account and registering the accessory device and host device 802. The key server may then generate a master key using the host device identifier and the accessory device identifier 804. The master key and the accessory device identifier may then be delivered to an accessory trust agent provider 806 and the accessory trust agent provider may then generate an accessory token using the master key and the accessory device identifier 808. The accessory trust agent provider may then send the accessory token to the key server 810. Next, the key server may send the host device identifier and the master key to the host trust agent provider 812 and the host trust agent provider may generate a host token using the host device identifier and the master key 814. The host trust agent provider may then send the host token to the key server 816. Next, the accessory token and host token may be delivered to the accessory device over a forward link only interface 818.

### Dependent Trust Agents and Interactive Channel Delivery

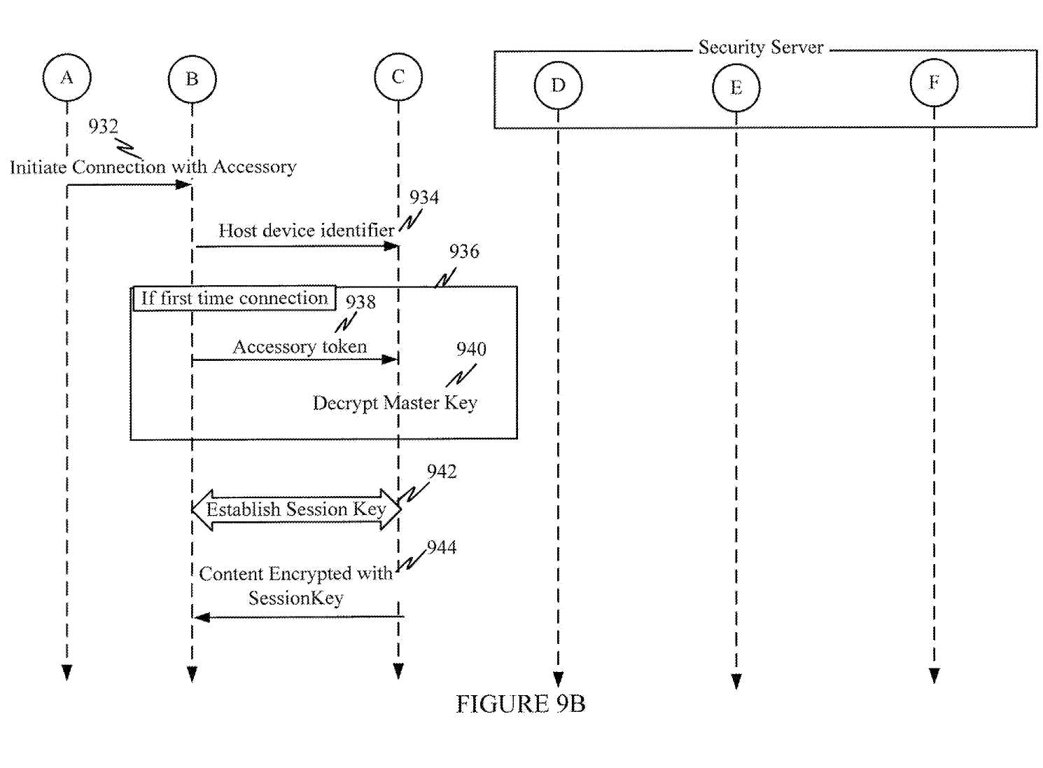

FIG. 9 (comprising FIGS. 9A and 9B) is a flow diagram illustrating a second example of establishing trust between an accessory device and host device. Similarly to the example illustrated in FIG. 2, an owner (or end user) 900 may establish trust between the accessory device 904 and the host device 902 through the security server 906. However, in this example, the accessory and host tokens may be delivered to the host device over the interactive channel and upon first connection; it is the host device who delivers the accessory token to the accessory device. The security server 906 may include a key server 908, a host trust agent provider 910 and an accessory trust agent provider 912. In other words, the end user may register the accessory device using the host device, such as an iPhone, by utilizing the web browser on the host device to complete the registration process. In this method, the browser, used through a 3G network, may be able to obtain the keys as explained above, however, in this instance, the host device may receive the keys first as it is running on the web browser. As the keys may now be sent to the host device on the 3G network, the host device can decrypt the master key and the other key may be sent to the accessory device so that a session may be established.

First, the owner (or end user) of the accessory device may initiate registration of the accessory device by sending an accessory device identifier to the host device 914. The host device may then send its host device identifier, as well as the accessory device identifier it received from the end user, to the security server for registering the accessory device 916. Upon receipt of the host device and accessory device identifiers, the key server may generate a master key using the identifiers 918. The key server may then deliver the accessory device ID, along with the master key, to the accessory trust agent provider 920. The accessory trust agent provider may then generate an accessory token using the accessory device ID and the master key 921 and send the accessory token to the key server 922. The key server may then send, or deliver, the host device ID along with the master key to the host trust agent provider 924. The host trust agent provider may then generate a host token using the host device ID and the master key 925 and send the host token to the key server 926.

Both accessory and host tokens may be delivered to the host device by the key server over a forward link only interface 928. The host device may then decrypt, or extract, the master key from the accessory token 930. Once the master key has been decrypted, the trust established with a previous master key may be revoked 931. The end user may then initiate the connection of the host device to the accessory device (i.e. a secure session) 932. The host device may then deliver its identifier (ID. HOST) to the accessory device 934. If this is the first time the host device is connecting to the accessory device 936, the host device may send the accessory token that corresponds to the host device ID to the accessory device 938. The accessory device may then decrypt, or extract, the master key from the accessory token 940. The host device and accessory device may then derive a session key from the master key 942 so that content may then be delivered from the accessory device to the host device encrypted with the session key 944.

Note that, (1) The trust established between the accessory device and host device can be made temporary by including an expiration time; (2) The key server can revoke or renew previously established trust between the accessory device and host device by delivering empty tokens, a token which includes a command to perform a task, or tokens with new master keys (the task may include a revocation of the master key); and (3) The host token may be delivered to the host device along with the MediaFLO application (user interface, player, etc.) that allows the host device to connect to the accessory device and render the service to the end user.

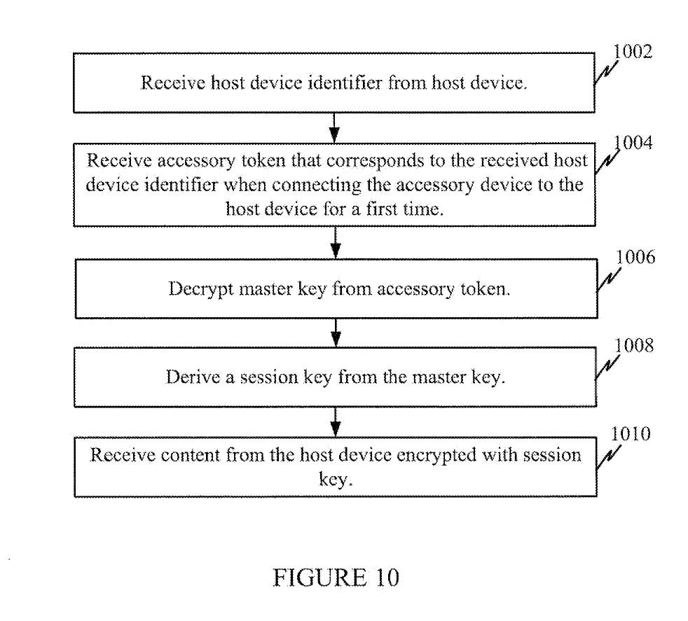

FIG. 10 illustrates a flow diagram of one example of a method, operational on an accessory device, for establishing trust between the accessory device and a host device. First, a host device identifier (ID.Host) may be received from the host device 1002. Next, an accessory token [MasterKey]_{ID.ACC} may be received from the host device when the host device is connecting to the accessory device for the first time 1004. Once the accessory token has been received, the accessory device may decrypt the master key from the accessory token 1006. The accessory device may then derive a session key from the master key that was decrypted from the accessory token 1008 so that content may then be delivered from the accessory device to the host device encrypted with the session key 1010. In one aspect, the content may be real-time content.

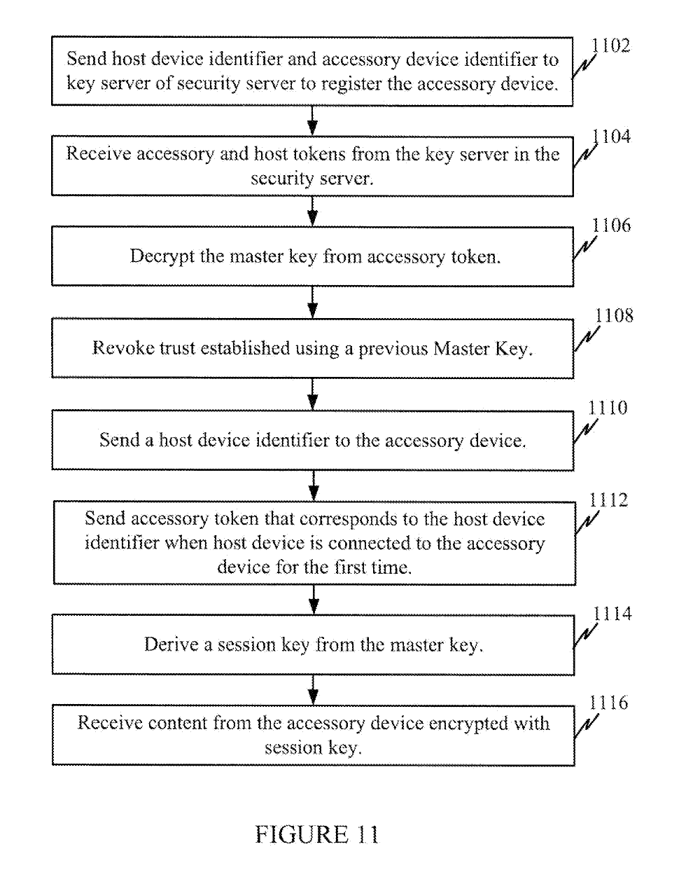

FIG. 11 illustrates a flow diagram of one example of a method, operational on a host device, for establishing trust between an accessory device and the host device. First, a host device identifier (ID.HOST) and an accessory device identifier (ID.ACC) may be sent to a key server in a security server to register the accessory device 1102. Next, accessory and host tokens may be received from the key server in the security server 1104. Upon receiving the accessory and host tokens, the host device may decrypt the master key from the accessory token 1106. Next, any trust established using a previous master key may be revoked 1008. The host device identifier (ID.HOST) may then be sent to the accessory device 1110.

The accessory token that corresponds to the host device identifier may then be sent to the accessory device when connecting to the accessory device for the first time 1112. Using the master key and the host device identifier, a session key may be derived 1114. The session key may be used to decrypt content which the host device receives from the accessory device that has been encrypted with the session key 116. In one aspect, the content may be real-time content.

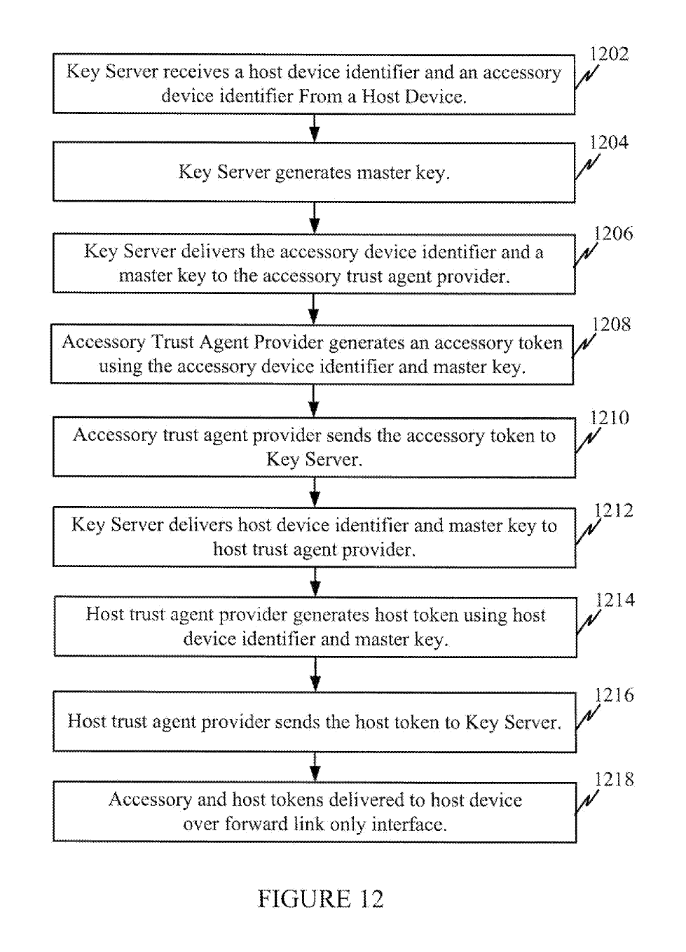

FIG. 12 illustrates a flow diagram of one example of a method, operational on a security server, for establishing trust between an accessory device and a host device. First, a key server may receive a host device identifier and accessory device identifier from an end user upon logging onto an account and registering the accessory device and host device 1202. The key server may then generate a master key using the host device I identifier and the accessory device identifier 1204. The master key and the accessory device identifier may then be delivered to an accessory trust agent provider in the security server 1206. After receiving the master key and the accessory device identifier, the accessory trust agent provider may then generate an accessory token using the master key and accessory device identifier 1208 and then send to the key server 1210. Next, the key server may deliver the host device identifier and the master key to the host trust agent provider 1212. After receiving the master key and the host device identifier, the host trust agent provider may then generate a host token using the host device identifier and the master key 1214 and send to the key server 1216. Once the key server has both the accessory device and host tokens, the key server may then send the accessory token and the device token to the host device over a forward link only interface 1218.

### Autonomous Trust Agents

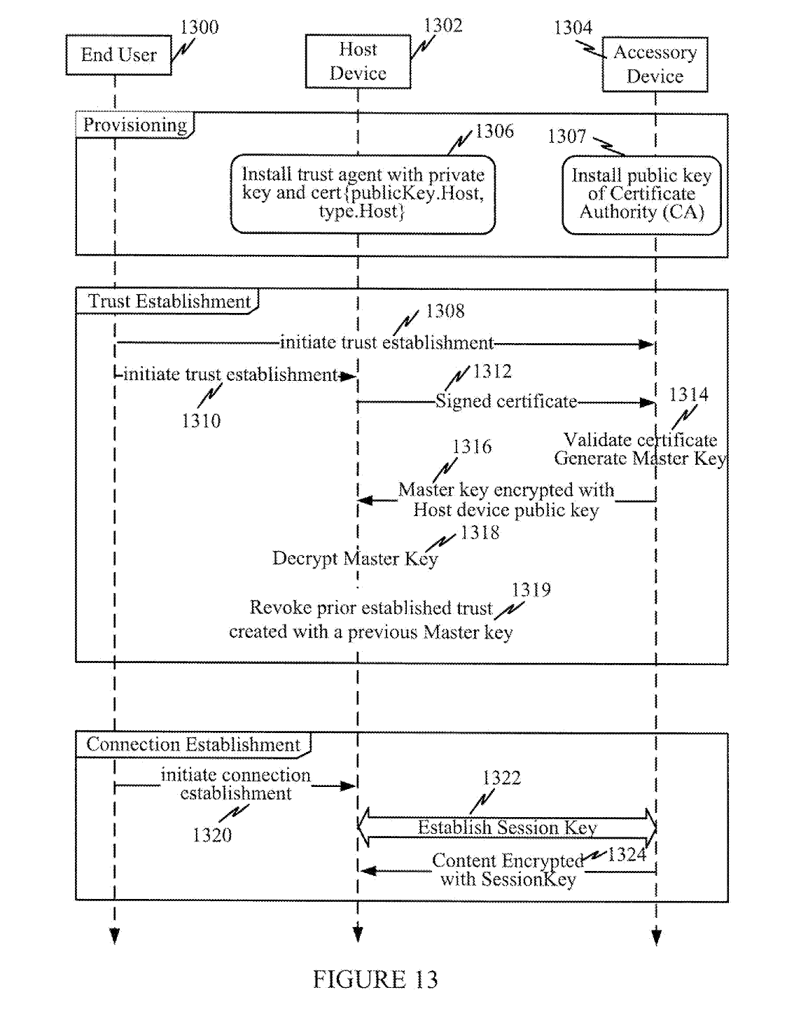

FIG. 13 is a flow diagram illustrating an example of establishing trust between an accessory device and host device. In this example, an owner (or end user) 1300 may establish trust between an accessory device 1304 and a host device 1302 without assistance from a security server. It may be assumed that there is a mechanism in place for the trust agent on the host device to authenticate to the accessory device and attest to the host device type.

Furthermore, in this example, the accessory device owner may initiate the trust establishment between the host device and accessory device via some method, e.g. by pressing a button on each device, or by connecting the two devices via a universal serial bus (USB) cable. By the accessory device owner (or end user) initiating the trust establishment, an adversary connecting his/her host device to an accessory device without the consent of the accessory device owner may be prevented.

As showing in FIG. 13, the trust agent on the host device may have been provisioned with a private key and a certificate signed by a Certificate Authority (CA) 1306. The certificate may contain the public key of the host device (publicKey.Host) and the type of the host device (type.Host). Additionally, a public key of the Certificate Authority (CA) may be installed on the accessory device 1307. The certificate authority may be used to validate certificates received from the host device.

In this method, the end user may initiate the trust establishment phase on the accessory device 1308 and host device 1310. For example, the end user may initiate the trust establishment phase by selecting a button on the host device, such as an iPhone, indicating the desire to start a secure communication. Next, the host device may send its signed certificate (cert{publickey.host, type.Host}) to the accessory device 1312. The certificate may include the public key of the host device and the type of the host device. In one aspect, the signed public key may be embedded inside an application which is downloaded inside the host device.

The accessory device may then validate the certificate using the public key of the certificate authority, confirm that the type of the host device is on an approved list of host devices (i.e. verify that the host device is a legitimate host device by checking the certificate authority) and generate the master key 1314. Next, the accessory device may deliver the master key to the host device encrypted with the public key of the host device 1316. The host device may then decrypt the master key 1318. Once the master key has been decrypted, trust established with a previous master key may be revoked 1319.

As both the host device and the accessory device may have the master key, the end user may initiate a secure connection of the host device to the accessory device 1320 and the host device and accessory device may each then derive a session key based on the master key 1322. Once the session key has been derived, content may then be delivered to the host device encrypted with the session key 1324. In one aspect, the content may be real-time content.

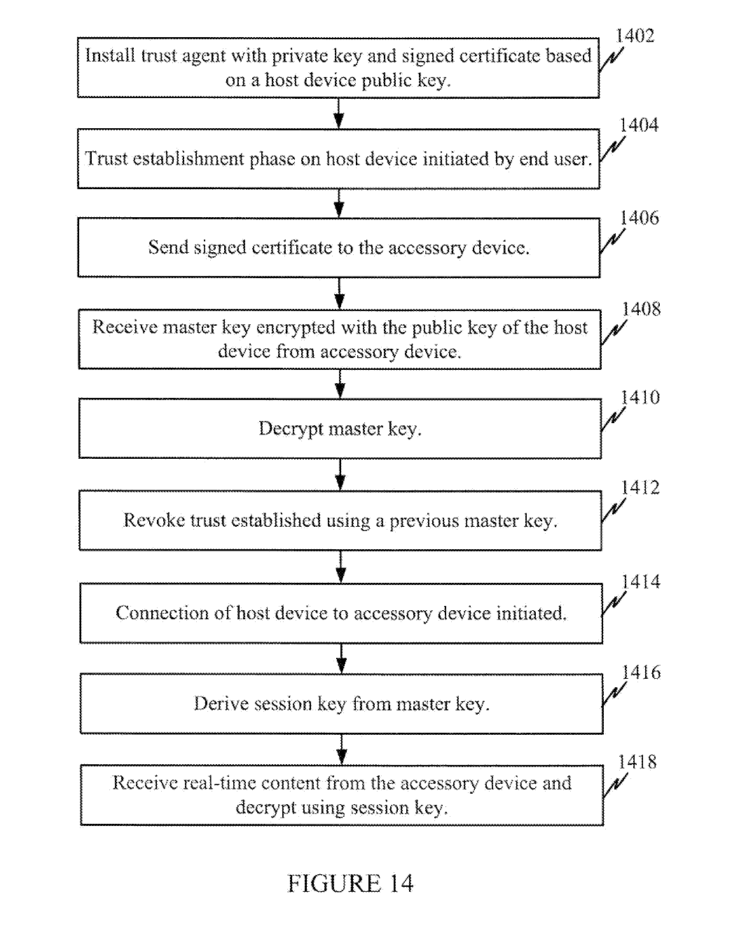

FIG. 14 illustrates a flow diagram of one example of a method, operational on a host device, for establishing trust between an accessory device and the host device. First, a trust agent on the host device may be provisioned with (or installed with) a private key and a signed certificate 1402. The signed certificate may be, for example, a certificate based on a host device public key (publicKey.Host) and a host device type (type.Host) which are signed by a Certificate Authority (CA) (e.g., cert{publicKey.Host, type.Host}). Once provisioned with the private key and signed certificate, the trust establishment phase on the host device may be initiated by the end user 1404 and the signed certificate cert{publicKey.Host, type. Host} may be sent to the accessory device 1406. The host device may then receive the master key encrypted with the public key of the host device from the accessory device 1408. Next, the master key may be decrypted 1410. Next, any trust established using a previous master key may be revoked 1412.

A connection between the host device and the accessory device may then be initiated with the host device by the end user 1414 and the host device may then derive a session key from the master key 1416. Content may be received from the accessory device and decrypted with the session key 1418. In one aspect, the content may be Real-time content.

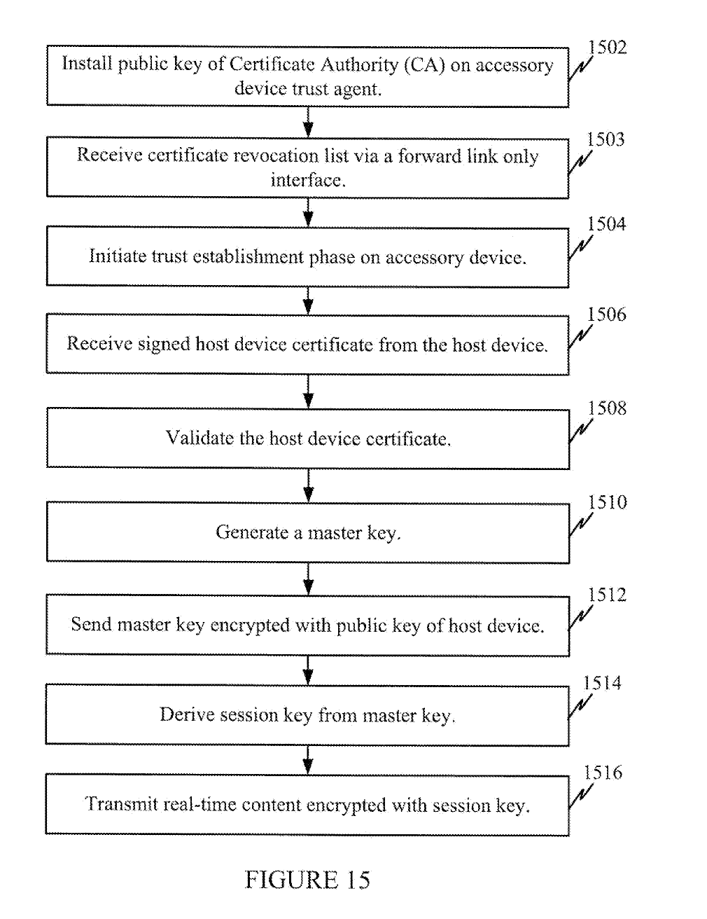

FIG. 15 illustrates a flow diagram of one example of a method, operational on an accessory device, for establishing trust between the accessory device and a host device. First, a public key of a certificate authority may be installed on a trust agent of the accessory device 1502. The accessory device may also receive a certificate revocation list via a forward link only interface 1503. The certificate revocation list may be received through software updates installed on the accessory device through direct connection of the accessory device to a personal computer or through a network line with the host device. Next, a trust establishment phase on the accessory device may be initiated by an end user 1504 and a signed host device certificate cert{publicKey.Host, type. Host} may be received from the host device 1506. The accessory device may then validate the host device certificate 1508 and generate the master key 1510. Next, the accessory device may send the master key, encrypted with the public key of the host device, to the host device 1512. The accessory device may derive a session key from the master key 1514 and so content, encrypted with the session key, may be sent to the host device 1516. In one aspect, the content may be real-time content.

One or more of the components, steps, and/or functions illustrated in FIGS. 1, 2, 3, 4, 5, 6, 7, 8, 9, 10, 11, 12, 13, 14 and/or 15 may be rearranged and/or combined into a single component, step, or function or embodied in several components, steps, or functions. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method, operational on a security server, for establishing trust between an accessory device and a host device, comprising:
receiving an accessory device identifier and a host device identifier via a first network;
generating an accessory token based on the accessory device identifier and a master key;
generating a host token using the host device identifier and the master key; and
sending the accessory token and the host token via a second network over a forward link only interface, the accessory token and the host token utilized to establish a session key between the accessory device and the host device.

2. The method of claim 1, wherein the security server includes a key server, a host trust agent provider and an accessory trust agent provider.

3. The method of claim 2, wherein the key server generates a master key and delivers the accessory device identifier and the master key to the accessory trust agent provider; and
wherein the accessory trust agent provider generates the accessory token using the accessory device identifier and the master key and delivers the accessory token to the key server.

4. The method of claim 3, wherein the key server delivers the host device identifier and master key to the host trust agent provider.

5. The method of claim 2, wherein the host trust agent provider generates the host token and delivers the host token to the key server.

6. The method of claim 1, wherein the accessory device is a forward link only receiver.

7. The method of claim 1, wherein the session key between the accessory device and the host device is temporary.

8. The method of claim 1, wherein the accessory token and the host token are sent to the accessory device via the forward link only interface.

9. The method of claim 1, wherein the key server delivers empty tokens, a command to perform a task or tokens with new master keys to revoke or renew the session key between the accessory device and the host device.

10. The method of claim 9, wherein the task is to revoke the master key.

11. The method of claim 1, further comprising:
delivering an application to the host device along with the host token, wherein the application is a user interface or a player that facilitates communications between the host device and the accessory device.

12. The method of claim 1, wherein the host device sends the host device identifier encrypted to the accessory device.

13. The method of claim 1, wherein the accessory device sends the host token to the host device.

14. A method, operational on a host device, for establishing trust with an accessory device, comprising:
sending an accessory device identifier and a host device identifier to a security server via a first network;
receiving an accessory token and a host token from the security server, via a second network, over a forward link only interface, the accessory token and the host token utilized to establish a session key between the accessory device and the host device;
decrypting a master key from the accessory token;
sending the host device identifier to the accessory device;
sending the accessory token to the accessory device when connecting the accessory device to the host device for a first time;
deriving a session key from the master key; and
receiving content from the accessory device encrypted with the session key via the first network.

15. The method of claim 14, wherein the content is real-time content.

16. The method of claim 14, wherein the accessory device is a forward link only receiver.

17. The method of claim 14, wherein the session key between the accessory device and the host device is temporary.

18. The method of claim 14, further comprising:
receiving an application along with the host token, wherein the application is a user interface or a player that facilitates communications between the host device and the accessory device.

19. The method of claim 14, further comprising revoking a prior trust established between the host device and the accessory device using a previous master key.

20. A host device for establishing trust with an accessory device, the host device comprising:
a first communication interface for communicating with a subscriber-based service;
a second communication interface for communicating with the accessory device; and
a processing circuit coupled to the first and second communication interfaces, the processing circuit adapted to
send an accessory device identifier and a host device identifier to a security server via a first network;
receive an accessory token and a host token from the security server, via a second network, over a forward link only interface, the accessory token and the host token utilized to establish a session key between the accessory device and the host device;
decrypt a master key from the accessory token;
send the host device identifier to the accessory device;
send the accessory token to the accessory device when connecting the accessory device to the host device for a first time;
derive a session key from the master key; and
receive content from the accessory device encrypted with the session key via the first network.

21. A host device for establishing trust with an accessory device, the host device comprising:
means for sending an accessory device identifier and a host device identifier to a security server via a first network;
means for receiving an accessory token and a host token from the security server, via a second network, over a forward link only interface, the accessory token and the host token utilized to establish a session key between the accessory device and the host device;
means for decrypting a master key from the accessory token;
means for sending the host device identifier to the accessory device;
means for sending the accessory token to the accessory device when connecting the accessory device to the host device for a first time;
means for deriving a session key from the master key; and
means for receiving content from the accessory device encrypted with the session key via the first network.

22. A computer-readable medium comprising instructions executable by a processor for establishing trust between an accessory device and a host device, comprising:
send an accessory device identifier and a host device identifier to a security server via a first network;
receive an accessory token and a host token from the security server, via a second network, over a forward link only interface, the accessory token and the host token utilized to establish a session key between the accessory device and the host device:
decrypt a master key from the accessory token;
send the host device identifier to the accessory device;
send the accessory token to the accessory device when connecting the accessory device to the host device for a first time;
derive a session key from the master key; and
receive content from the accessory device encrypted with the session key via the first network.

23. A method, operational on an accessory device, for establishing trust with a host device, comprising:
receiving a host device identifier from the host device;
receiving an accessory token, corresponding to the host device identifier, from the host device when connecting the accessory device to the host device for a first time;
decrypting a master key from the accessory token;
deriving a session key from the master key; and
transmitting content to the host device encrypted with the session key.

24. The method of claim 23, wherein the content is real-time content.

25. The method of claim 23, wherein the accessory device is a forward link only receiver.

26. The method of claim 23, wherein the session key between the accessory device and the host device is temporary.

27. An accessory device for establishing trust with a host device, the accessory device comprising:
a first communication interface for communicating with a subscriber-based service;
a second communication interface for communicating with the host device; and
a processing circuit coupled to the first and second communication interfaces, the processing circuit adapted to
receive a host device identifier from the host device;
receive an accessory token, corresponding to the host device identifier, from the host device when connecting the accessory device to the host device for a first time;
decrypt a master key from the accessory token;
derive a session key from the master key; and
transmit content to the host device encrypted with the session key.

28. An accessory device for establishing trust with a host device, the accessory device comprising:
means for receiving a host device identifier from the host device;
means for receiving an accessory token, corresponding to the host device identifier, from the host device when connecting the accessory device to the host device for a first time;
means for decrypting a master key from the accessory token;
means for deriving a session key from the master key; and
means for transmitting content to the host device encrypted with the session key.

29. A computer-readable medium comprising instructions executable by a processor for establishing trust between an accessory device and a host device, comprising:
receive a host device identifier from the host device;
receive an accessory token, corresponding to the host device identifier, from the host device when connecting the accessory device to the host device for a first time;
decrypt a master key from the accessory token;
derive a session key from the master key; and
transmit content to the host device encrypted with the session key.

30. An accessory device for establishing trust with a host device, the accessory device comprising:
a first communication interface for communicating with a subscriber-based service;
a second communication interface for communicating with the host device; and
a processing circuit coupled to the first and second communication interfaces, the processing circuit adapted to
receive an accessory token and a host token from a security server via a second network over a forward link only interface;
decrypt a master key from the accessory token;
receive a host device identifier from the host device via a first network;
send the host token to the accessory device, via the first network, when connecting the accessory device to the host device for a first time;
derive a session key from the master key; and
deliver content to the host device encrypted with the session key via the first network.

31. A host device for establishing trust with an accessory device, the host device comprising:
a first communication interface for communicating with a subscriber-based service;
a second communication interface for communicating with the accessory device; and
a processing circuit coupled to the first and second communication interfaces, the processing circuit adapted to
deliver a host device identifier to the accessory device;
receive a host token from the accessory device;
decrypt a master key from the host token;
derive a session key from the master key; and
receive content from the accessory device encrypted with the session key.

32. An accessory device for establishing trust with a host device, the accessory device comprising:
a first communication interface for communicating with a subscriber-based service;
a second communication interface for communicating with the host device; and
a processing circuit coupled to the first and second communication interfaces, the processing circuit adapted to
install a public key of a certificate authority in a trust agent of the accessory device;
receive a certificate revocation list, the certificate revocation list is received via a forward link only interface, through software updates installed on the accessory device through direct connection of the accessory device to a personal computer or through a network line with the host device;
receive a signed certificate from the host device, the signed certificate including a public key of the host device and type of the host device;
validate the signed certificate using the public key of the certificate authority and confirming that the type of the host device is on an approved list;
generate a master key from the signed certificate;
send the master key to the host device encrypted with the public key of the host device;
derive a session key from the master key; and
transmit content to the host device encrypted with the session key.

33. A host device for establishing trust with an accessory device, the host device comprising:
a first communication interface for communicating with a subscriber-based service;
a second communication interface for communicating with the accessory device; and
a processing circuit coupled to the first and second communication interfaces, the processing circuit adapted to
install a private key and a certificate authority on a trust agent of the host device;
send a signed certificate to the accessory device;
receive a master key encrypted with a public key of the host device from the accessory device;
decrypt the master key the master key using the public key;
revoke a trust previously established with a previous master key;
derive a session key from the master key; and
receive content to the host device encrypted with the session key.
